(19) United States
(12) Patent Application Publication
(10) Pub. No.: US 2025/0166016 A1
(43) Pub. Date: May 22, 2025

(54) ADVERTISEMENT DISPLAYING SYSTEM, ADVERTISEMENT DISPLAYING METHOD, AND NON-TRANSITORY COMPUTER READABLE MEDIUM STORING COMPUTER PROGRAM

(71) Applicant: RAKUTEN GROUP, INC., Tokyo (JP)

(72) Inventor: Tuba ALI, Tokyo (JP)

(73) Assignee: RAKUTEN GROUP, INC., Tokyo (JP)

(21) Appl. No.: 18/663,552

(22) Filed: May 14, 2024

(30) Foreign Application Priority Data
Nov. 20, 2023 (JP) 2023-196725

(51) Int. Cl. G06Q 30/0251; G06K 19/06; G07F 17/32

(52) U.S. Cl. CPC G06Q 30/0268; G06K 19/06037; G07F 17/329; G07F 17/3295

(57) ABSTRACT

An advertisement displaying method causes one or more computers to transmit first data for displaying a first settlement screen in association with a first settlement process, the first settlement screen including one or more first advertisement slots, and an advertisement displayed in the one or more first advertisement slots including a redisplay button, when the redisplay button is turned on in the first settlement screen, enable redisplay setting of an designated advertisement including the turned-on redisplay button as a designated advertisement, and transmit second data for displaying a second settlement screen in association with a second settlement process after the redisplay setting is enabled, the second settlement screen including one or more second advertisement slots for displaying an advertisement, and the second data including data of one or more of the designated advertisement to be displayed in the one or more second advertisement slots.

### CROSS-REFERENCE TO RELATED APPLICATIONS

This application is based upon and claims the benefit of priority from prior Japanese Patent Application No. 2023-196725, filed on Nov. 20, 2023, the entire contents of which are incorporated herein by reference.

### BACKGROUND

### 1. Field

The present disclosure relates to an advertisement displaying system, an advertisement displaying method, and a non-transitory computer readable medium storing a computer program.

### 2. Description of Related Art

In general, when performing code settlement, which is an example of an electronic settlement, a user installs a settlement application in his/her mobile terminal. A main function of the settlement application is to display a user code for identifying the user.

A code display screen on which the user code of the settlement application is displayed may include multiple advertisements. However, the code display screen transitions to a settlement completion screen immediately after the settlement process is finished. Therefore, the settlement screen of the settlement application, such as the code display screen, generally has a short display time.

For example, Japanese Laid-Open Patent Publication No. 2023-61602 discloses a settlement application capable of registering advertisements included in the code display screen as favorites in order to compensate for the short display time. The settlement application displays advertisements registered as favorites on a list screen and allows for viewing of contents associated with the advertisements from the list screen.

As described above, the advertisement included in the settlement screen of the settlement application has a drawback in that even if the user is interested in an advertisement, the user does not have time to slowly view the advertisement. Further, since the terminal used by a user is often a mobile terminal, there is no space for displaying all the advertisement contents. Therefore, a banner advertisement displayed on the settlement screen is mostly an image button with a link. In this case, the user needs to open the linked advertisement page to learn more about the content of the advertisement, which requires additional time for browsing. Given these circumstances, there is a demand for more effective display methods for advertisements included on the settlement screen.

An objective of the present disclosure is to provide an advertisement displaying system, an advertisement displaying method, and a computer program capable of effectively displaying advertisements on a settlement screen.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an advertisement displaying system includes one or more servers. At least one of the one or more servers is configured to transmit, to a user terminal, data for displaying a settlement screen in association with a settlement process. The settlement screen includes one or more advertisement slots, and an advertisement displayed in the one or more advertisement slots including a redisplay button. At least one of the one or more servers is configured to transmit advertisement data to be displayed in the one or more advertisement slots. At least one of the one or more servers is configured to enable, when the redisplay button is turned on, a redisplay setting of an advertisement including the turned-on redisplay button as a designated advertisement. When the redisplay setting of one or more of the designated advertisements is enabled, the advertisement data includes data of one or more of the designated advertisements to be displayed in at least one of the one or more advertisement slots.

In another general aspect, an advertisement displaying method includes causing one or more computers to: transmit, to a user terminal, first data for displaying a first settlement screen in association with a first settlement process, the first settlement screen including one or more first advertisement slots, and an advertisement displayed in the one or more first advertisement slots including a redisplay button; when the redisplay button is turned on in the first settlement screen, enable redisplay setting of an advertisement including the turned-on redisplay button as a designated advertisement; and transmit, to the user terminal, second data for displaying a second settlement screen in association with a second settlement process after the redisplay setting is enabled, the second settlement screen including one or more second advertisement slots for displaying an advertisement, and the second data including data of one or more of the designated advertisement to be displayed in the one or more second advertisement slots.

In a further general aspect, a non-transitory computer readable medium stores a computer program configured to cause a user terminal to: display a settlement screen in association with a settlement process, the settlement screen including one or more advertisement slots, and an advertisement displayed in the one or more advertisement slots including a redisplay button; when the redisplay button is turned on, transmit, to a server, information of the advertisement for which the redisplay button has been turned on, the advertisement for which the redisplay button has been turned on being a designated advertisement; and display the designated advertisement in at least one of the one or more advertisement slots when receiving advertisement data including the data of the designated advertisement.

Other features and aspects will be apparent from the following detailed description, the drawings, and the claims.

### BRIEF DESCRIPTION OF THE DRAWINGS

FIG. 1 is a schematic diagram showing a configuration of an advertisement displaying system according to an embodiment.

FIG. 2 is a block diagram showing an example of an electrical configuration of a server in the advertisement displaying system shown in FIG. 1.

FIG. 3 is a diagram showing an example of a settlement completion screen.

FIG. 4 is a diagram showing a code display screen.

FIG. 5 is a diagram showing an example of a list screen for favorite advertisements.

FIG. 6 is an explanatory flowchart of a method for displaying a code display screen.

FIG. 7 is an explanatory flowchart of a method for registering an advertisement as a favorite.

FIG. 8 is an explanatory flowchart of a method for displaying an advertisement in association with a code settlement process.

FIG. 9 is an explanatory flowchart of a method for enabling a redisplay setting for a designated advertisement.

FIG. 10 is an explanatory flowchart of a method for generating advertisement data.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

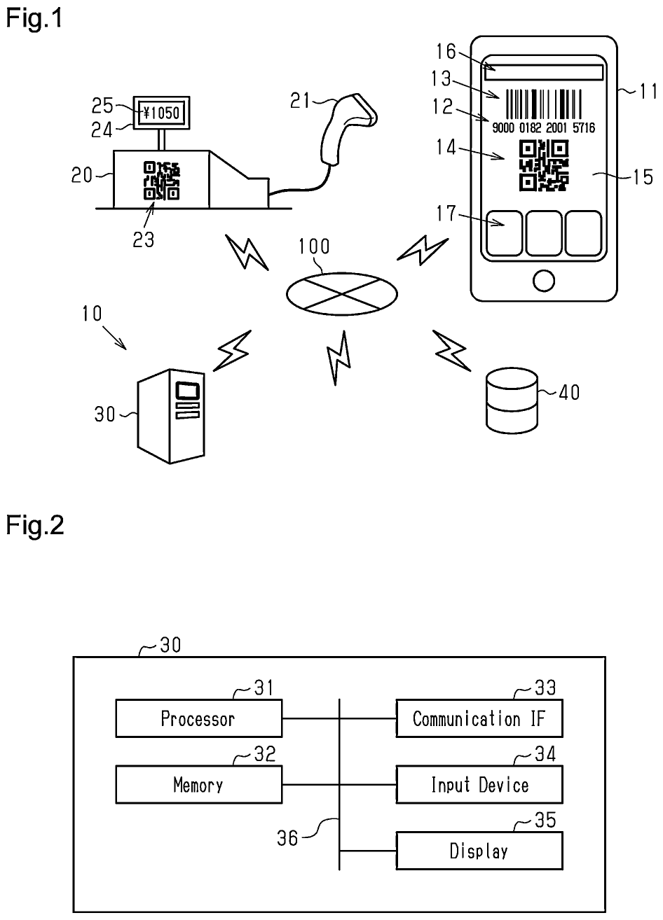

Hereinafter, examples of an advertisement displaying system 10, an advertisement displaying method, and a non-transitory computer readable medium in which a computer program (settlement application) is recorded will be described with reference to FIGS. 1 to 6. The present disclosure is not limited to those exemplified and is shown by the scope of the claims. It is intended to include all modifications within the meaning and range equivalent to the scope of the claims.

### System for Electronic Settlement and Display of Advertisement

As shown in FIG. 1, a system 10 for providing an electronic settlement service and an advertisement distribution service includes one or more servers 30. The one or more servers 30 are configured to perform settlement process and transmission of advertisement data. Various functions of the system 10, for example, the settlement process and the transmission of advertisement data may be implemented by one server 30 or multiple servers 30.

Hereinafter, an example will be described in which one server 30 performs both operations of a settlement information transmission unit, which transmits data for displaying a settlement screen to a user terminal 11 in association with a settlement process, and an advertisement transmission unit, which transmits advertisement data. Further, the server 30 may be configured to perform a settlement process of an electronic settlement using a code (hereinafter, also simply referred to as “code settlement”). The code settlement may be performed through the user terminal 11 used by the user who performs the payment and a merchant terminal 20 used by a merchant who receives the payment.

A settlement application for code settlement is installed in the user terminal 11. The user terminal 11 may be, for example, a mobile terminal such as a smartphone, a smart watch, or a tablet having a computer and a camera built therein, but is not limited thereto.

The server 30 is configured to transmit advertisement data for displaying an advertisement on a settlement screen of the user terminal 11 to the user terminal 11. When the user terminal 11 receives the advertisement data, the settlement application displays a corresponding advertisement on the settlement screen of the user terminal 11. Therefore, the server 30 and the settlement application are configured to execute a settlement process and display an advertisement on a settlement screen in cooperation with each other. Therefore, the passage “the server 30 causes the user terminal 11 to display a screen” includes the server 30 transmitting data for causing the user terminal 11 to display a screen to the user terminal 11 or a device that relays data transmission.

The settlement application includes a computer program for causing the user terminal 11 to execute various operations. When the user activates the settlement application, a code display screen 15 is displayed. The code display screen 15 includes one or more user codes 12, 13, 14. The user codes 12, 13, 14 include user identification information for identifying the user and settlement identification information for identifying the settlement process. The user codes 12, 13, 14 may be generated each time the settlement application is activated, may be regenerated by a reload button, or may have a valid time (for example, 5 minutes).

Among the codes 12, 13, 14, the code 12 is a character string of multiple digits including at least one of a number, a character, and a symbol. The codes 13, 14 are two-dimensional codes. The two-dimensional codes 13, 14 may be a barcode 13 or a QR Code® 14, but are not limited thereto. The two-dimensional codes 13, 14 are generated by the settlement application converting the character string code 12 into a two-dimensional code. Therefore, when the code display screen 15 is scanned, the expression “the user code 12 is read” is used even if what is actually scanned is the user code 13 or 14.

The merchant terminal 20 is operated by a merchant who participates in the electronic settlement service. The merchant terminal 20 may be installed in a store or may be mounted on a mobile unit such as a taxi or a mobile vending vehicle. Each merchant terminal 20 may be a point-of-sale (POS) cash register, or a mobile device such as a PC or a tablet in which a store settlement application is installed.

The merchant terminal 20 may include a code scanner 21 for scanning the user code 12, or may include a code reading camera and a code reading application. A store code 23 is assigned to the merchant terminal 20 in advance. The store code 23 is associated with identification information for identifying a merchant, a store, or the merchant terminal 20 that participates in the electronic settlement service. Hereinafter, identification information for identifying a merchant, a store, or the merchant terminal 20 is referred to as merchant identification information.

The system 10 may include one or more databases 40. The one or more databases 40 include data related to multiple users, multiple merchants (or stores), and advertisements to be distributed to the users. The one or more databases 40 may include multiple databases such as a user database, a merchant (store) database, a settlement database, and an advertisement database, or may be a database obtained by integrating these databases.

The user database stores various data related to multiple users registered in the electronic settlement service. Examples of the information related to a user include, but are not limited to, the name of the user, user identification information, the physical address of the user, the place of work, an account, an email address, and settlement-related information. An example of the settlement-related information is a credit card number, a debit card number, or a debit account number. The user database may include a settlement history of each user. The settlement history, for example, contains the names of the stores where settlements were made, the date and time of settlement (settlement date, day of the week, and time), the items of the transaction, and the settlement amount.

The merchant database stores various data related to multiple merchants participating in the electronic settlement service. Examples of the information related to a merchant includes, but are not limited to, the name of the merchant, merchant identification information (including store identification information), the location, business contents, fields of products handled and services provided, and location information of the merchant terminal 20. As the location information of the merchant terminal 20 mounted on the mobile unit, a representative location or range may be stored in the merchant database, or information obtained by, for example, a GPS may be used. The merchant database may include a settlement history. The settlement history, for example, contains the names of stores where settlements were made, the payers (users), the dates and times of settlement, the items of the transactions, and the settlement amounts.

The settlement database stores the history of multiple settlement processes. The history of the settlement processes may include, for example, user identification information, merchant identification information (store identification information), store information, settlement dates and times, settlement locations, settlement amounts, payment methods, transaction contents, and the withdrawal status after the settlement process in each settlement process.

The advertisement database stores various data related to multiple advertisements to be distributed to the user terminal 11. For example, the information related to each advertisement includes advertisement identification information, the distribution period of the advertisement, the expiration date of advertisement content, the advertiser, the genre or type of the advertisement, the product or the content of the service related to the advertisement, a campaign name, distribution targets of the advertisement, distribution conditions of the advertisement, and the advertisement content. At least one of the distribution target and the distribution condition of the advertisement may be specified by the advertiser.

The server 30 may include a part or all of the database 40 or may be able to access the database 40 through the network 100. The server 30 can communicate with multiple merchant terminals 20 and multiple user terminals 11 through the network 100. When the system 10 includes multiple servers 30, the multiple servers 30 can also communicate with each other through the network 100.

The network 100 includes, for example, the Internet, a wide area network (WAN), a local area network (LAN), a provider terminal, a wireless communication network, a wireless base station, and a dedicated line.

It is not necessary for all combinations of the devices shown in FIG. 1 to be able to communicate with each other, and the network 100 may include a partial local network. For example, at least some of the multiple servers 30 may be able to communicate with each other through a local network.

### Configuration of Server

FIG. 2 shows a basic configuration of a computer as an example of the server 30. The computer includes, for example, one or more processors 31, one or more memories 32, and a communication interface (IF) 33.

The computer may further include an input device 34 and a display 35. The one or more processors 31, the one or more memories 32, the communication IF 33, the input device 34, and the display 35 are connected to each other by a communication bus 36. When the system 10 includes multiple servers 30, the configurations thereof may be the same or different from each other.

Each of the one or more processors 31 is, for example, processing circuitry configured to execute various types of software processing. The processing circuitry may include a dedicated hardware circuit (such as an ASIC) that executes at least part of the software processing. That is, the software processing may be executed in any manner as long as it is executed by processing circuitry that includes at least one of a set of one or more software processing circuits and a set of one or more dedicated hardware circuits.

Each of the one or more processors 31 is, for example, a central processing unit (CPU), a graphics processing unit (GPU), a microprocessor unit (MPU), a field-programmable gate array (FPGA), or any other arithmetic unit. The processor 31 executes a series of instructions included in a computer program stored in the memory 32 in response to a given signal or when a predetermined condition is met.

The one or more memories 32 may include, for example, a random access memory (RAM) or any other volatile memory. The memory 32 may be configured to temporarily store programs and data. The one or more memories 32 may include storage for permanently storing data including programs. The programs include applications and an operating system. The storage may be, for example, a read-only memory (ROM), a hard disk device, a flash memory, or any other non-volatile storage device. The storage may be a detachable storage device such as a memory card.

The communication IF 33 is configured to connect to the network 100. The communication IF 33 is configured to communicate with other devices connected to the network 100. The communication IF 33 is implemented as, for example, a local area network (LAN) or any other wired communication IF. The communication IF 33 may be implemented as, for example, WiFi®, Bluetooth®, or any other wireless communication IF, but is not limited thereto.

The input device 34 is, for example, a keyboard and a mouse, and may include buttons, keys, switches, a touchpad, or a microphone. The display 35 may be, for example, a liquid crystal monitor or an organic electro luminescence (EL) monitor, or may be a touch screen having a touch panel that also serves as the input device 34.

### Overview of Electronic Settlement Service

As shown in FIG. 1, when the user performs payment by code settlement of a store scan system, a payment screen 25 is displayed on the display 24 of the merchant terminal 20. The payment amount is displayed on the payment screen 25. After both the merchant and the user confirm the settlement amount, the user activates the settlement application to display the code display screen 15. When the merchant terminal 20 reads the user code 12 displayed on the code display screen 15, the merchant terminal 20 executes a payment process.

When the payment process is executed, the merchant terminal 20 transmits settlement information to the server 30 through the network 100. The settlement information includes the user code 12, the store code 23, and the settlement amount. The settlement information may further include transaction information related to the settlement, for example, information related to a purchased product.

In the case of a user scan system, the user reads the store code 23 using the settlement application of the user terminal 11. Then, a payment screen (not shown) is displayed on the user terminal 11. When the user inputs a payment amount on the payment screen and executes a payment process, settlement information including the user code 12, the store code 23, and the settlement amount is transmitted from the user terminal 11 to the server 30 via the network 100.

When receiving the settlement information from the merchant terminal 20 or the user terminal 11, the server 30 executes the settlement process. Thereafter, the server 30 transmits settlement completion information for displaying a settlement completion screen 60 to both the user terminal 11 and the merchant terminal 20. The settlement completion information may include the merchant information, the settlement date and time, and the settlement amount.

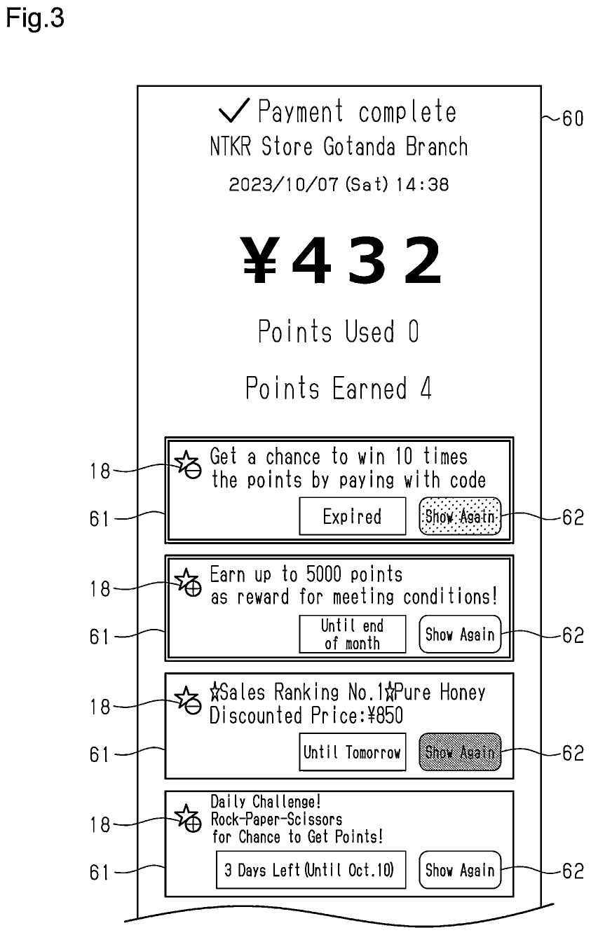

As shown in FIG. 3, when the settlement application receives the settlement completion information, the settlement application displays the settlement completion screen 60 on the user terminal 11. As a result, the code display screen 15 transitions to the settlement completion screen 60 in the case of a store scan system, and the payment screen transitions to the settlement completion screen 60 in the case of a user scan system. The “settlement screen” is a screen displayed on the user terminal 11 by the server 30 and the settlement application, and includes at least the code display screen 15 and the settlement completion screen 60, unless otherwise specified, and may further include a payment screen (not shown).

### Advertisements Displayed on Settlement Screen

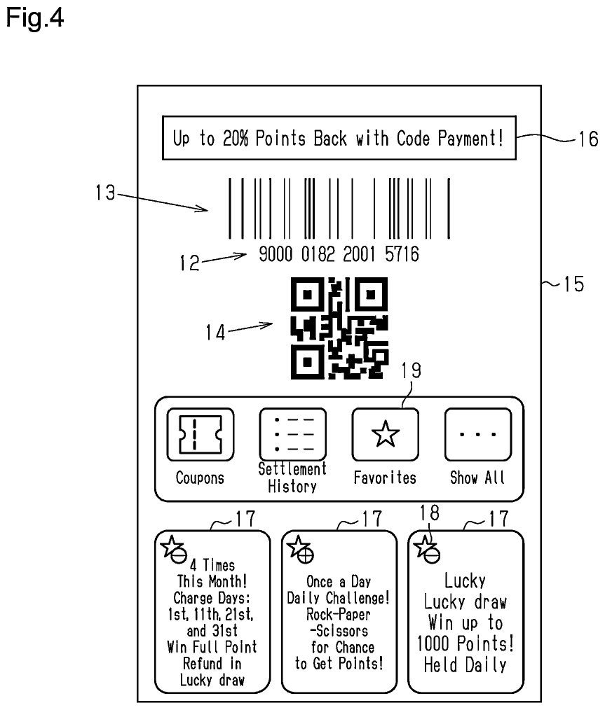

As shown in FIG. 4, the code display screen 15 may include one or more advertisement slots 16, 17 in addition to the code display area for displaying the user codes 12, 13, 14. The advertisement slot 16 is arranged, for example, above the code display area, and the multiple advertisement slots 17 are arranged below the code display area. The multiple advertisement slots 17 may be scrolled in a direction in which the advertisement slots 17 are arranged (horizontal direction in FIG. 4) so that the number of the advertisement slots 17 exceeding the screen width can be viewed.

The advertisement slot 16 may be a horizontally elongated banner advertisement to be distributed to all users. The multiple advertisement slots 17 may be dynamic banner advertisements having different display contents according to the user. When the server 30 transmits advertisement data to be displayed in the multiple advertisement slots 17, the advertisement data may include data of different advertisements for each settlement process or for each user terminal 11 to which the advertisement data is transmitted.

The banner advertisement displayed in each of the advertisement slots 16, 17 may be an image button with a link. When the user turns on (for example, taps) the image button, the linked advertisement page is displayed on the user terminal 11. The advertisement page includes, for example, detailed information of the advertisement content, the content of a campaign, the promotion period, and the requirement for participation in the campaign. Such an image button is also called a call-to-action (CAT) button, and is designed to induce the user to perform an action for viewing the detailed contents of the advertisement. In particular, since the advertisement slots 16, 17 of the code display screen 15 are too small to post detailed information, the content of the advertisement displayed in the advertisement slots 16, 17 is limited.

The advertisement displayed in each advertisement slot 17 may include a registration button 18 for registering the advertisement as a favorite. When the user operates (for example, taps) the registration button 18, the advertisement is registered in the user database by the settlement application and the server 30 as a favorite advertisement of the user. Turning on the registration button 18 is also referred to as performing favorite registration. The code display screen 15 may include a favorite advertisement display button 19 for displaying a list of one or more advertisements registered as favorites.

The registration button 18 may change its display from an off state to an on state when the registration button 18 is turned on (for example, tapped) for the first time. By this turn-on operation, the operated advertisement is registered as a favorite. The registration button 18 in the on state may return to the display indicating the off state from the on state by the second tap (turn-off operation). By the turn-off operation, the favorite registration of the operated advertisement may be canceled.

In FIG. 4, a star mark shown in each of the three advertisement slots 17 is a mark indicating a favorite, and a plus mark overlapping the star mark in the middle advertisement slot 17 indicates an off state (before registration). Further, in FIG. 4, in the advertisement slots 17 at the ends of the three advertisement slots 17, a minus mark overlapping the star mark indicates an on state (registered). The display indicating the on state and the off state can be changed to another representation such as changing the color of the star mark or reversing the color.

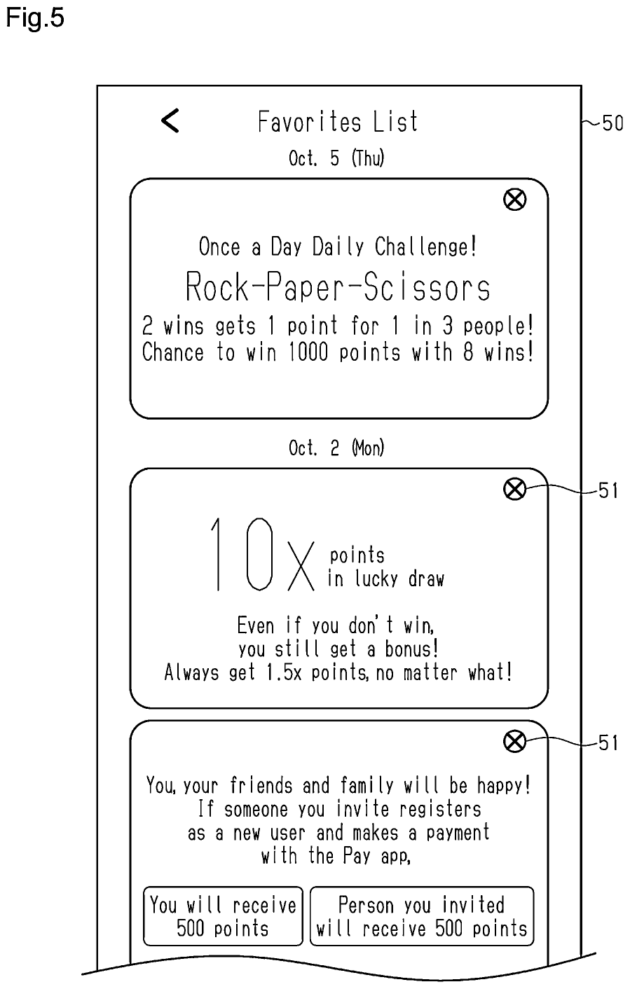

FIG. 5 shows a list screen 50 for displaying a list of favorite advertisements registered as favorites. On the list screen 50, an advertisement image registered as a favorite or an advertisement image that is associated with the registered advertisement image and includes more detailed information is displayed for each registration date and time, for example. The order of multiple advertisements may be based on the advertisements' expiration dates, approaching soonest first, or it may be based on the order in which the advertisements have been registered as favorites. The multiple advertisement images displayed on the list screen 50 may be scrolled in the direction in which they are arranged (the vertical direction in FIG. 5), for example, so that the number of advertisement images exceeding the screen length can be viewed.

For each user, favorite advertisements may be stored in the user database as favorite registration information together with the identification information of the advertisements. The favorite registration information may include registration date and time, the type of advertisements, and the expiration dates of advertisement contents. A registration cancellation button 51 may be displayed on the advertisement displayed on the list screen 50. When the user turns on the registration cancellation button 51, the server 30 updates the user database, and the registration of the corresponding favorite advertisement is cancelled.

As shown in FIG. 3, the settlement completion screen 60 may include multiple advertisement slots 61. The multiple advertisement slots 61 may be, for example, horizontally elongated and arranged in the longitudinal direction of the screen. The multiple advertisement slots 61 may be arranged below the settlement information. The multiple advertisement slots 61 may be scrolled in a direction in which the advertisement slots 61 are arranged (vertical direction in FIG. 3) so that the advertisement slots 61 of the number exceeding the screen length can be viewed. The number of the advertisement slots 61 may have an upper limit, and in this example, a maximum of five advertisement slots 61 are displayed.

The banner advertisement displayed in each advertisement slot 61 may be a dynamic banner advertisement having different display contents according to the user. The banner advertisement may be an image button with a link. When the user taps the image button, the linked advertisement page is displayed on the user terminal 11. The advertisement displayed in the advertisement slot 61 may be the same as or different from the advertisement displayed in the advertisement slot 17. For example, even when an advertisement of the same campaign is displayed in the advertisement slot 61 and the advertisement slot 17, an image having vertical and horizontal dimensions different from those of the advertisement slot 17 may be displayed together with the horizontally elongated advertisement slot 61.

The advertisement displayed in each advertisement slot 61 may include a redisplay (Show Again) button 62 in addition to the registration button 18 or instead of the registration button 18. When the user operates (for example, taps) the redisplay button 62, the advertisement is stored as a designated advertisement in the user database by the settlement application and the server 30. The designated advertisement is displayed again on the settlement completion screen 60 for the next time and thereafter. Turning on a redisplay button 62 is also referred to as enabling a redisplay setting of an advertisement.

The redisplay button 62 may change its display from an off state to an on state when the redisplay button 62 is turned on (for example, tapped) for the first time. By this turn-on operation, the redisplay setting of the operated advertisement is enabled. The redisplay button 62 in the on state may return to the display indicating the off state from the on state by the second tap (turn-off operation). By this turn-off operation, the redisplay setting of the advertisement may be disabled. In FIG. 3, the second lowest redisplay button 62 is in the on state, and the redisplay buttons 62 above and below the second lowest redisplay button 62 are in the off state.

The advertisement displayed in each advertisement slot 17 may include a redisplay button 62 in addition to the registration button 18 or instead of the registration button 18. In this case, an advertisement for which the redisplay setting has been enabled on the code display screen 15 may be redisplayed on the settlement completion screen 60, and an advertisement for which the redisplay setting has been enabled on the settlement completion screen 60 may be displayed on the code display screen 15. Alternatively, the advertisement for which the redisplay setting has been enabled on the code display screen 15 may be displayed on the code display screen 15, and the advertisement for which the redisplay setting has been enabled on the settlement completion screen 60 may be displayed on the settlement completion screen 60.

The settlement process when the redisplay button 62 is turned on is also referred to as a first settlement process. The settlement screen in the first settlement process is also referred to as a first settlement screen. The advertisement slots of the first settlement screen are also referred to as first advertisement slots. An advertisement for which the redisplay button 62 is turned on is also referred to as a designated advertisement. Data transmitted from the server 30 to the user terminal 11 in order to display the first settlement screen is also referred to as first data.

The settlement screen on which the designated advertisement is displayed is referred to as a second settlement screen. The second settlement screen is displayed along with a second settlement process, which is a settlement process after the first settlement process. Data transmitted from the server 30 to the user terminal 11 in order to display the second settlement screen is also referred to as second data. The advertisement slot of the second settlement screen is also referred to as a second advertisement slot. The second advertisement slot in which the designated advertisement is displayed is also referred to as a designated advertisement slot. The second advertisement slot in which the designated advertisement is not displayed is also referred to as a normal advertisement slot.

For each user, the redisplay setting of the advertisement may be stored in the user database as the redisplay setting information of the advertisement together with the identification information of the advertisement. The redisplay setting can be enabled for each advertisement. Thus, in a case in which there are multiple advertisement slots 61, the second settlement screen, on which a designated advertisement is displayed, can also be the first settlement screen, on which the redisplay setting is enabled for another advertisement.

The redisplayed designated advertisement may be redisplayed with the redisplay button 62 in the on state in advance. In this case, the designated advertisement is repeatedly redisplayed until the redisplay button 62 is turned off. Alternatively, the redisplayed designated advertisement may be redisplayed with the redisplay button 62 in the off state, similarly to the other advertisements. In this case, the redisplayed designated advertisement is not redisplayed unless the redisplay button 62 is turned on again.

The designated advertisement or the designated advertisement slot 61 that is redisplayed on the second settlement screen may include an expression different from those of the other advertisements or the normal advertisement slots 61. For example, the first and second advertisements from the top in FIG. 3 are redisplayed designated advertisements, and the designated advertisement slots 61 have a different design (a double frame in FIG. 3) from the normal advertisement slots 61.

In a case in which the advertisement content of the designated advertisement has an expiration date, the expiration date (for example, “until tomorrow”, “in three days”, “within this month”, or the date and time when the expiration date arrives) may be displayed on the second settlement screen together with the designated advertisement. The expiration date may be displayed only when the remaining time is short (for example, less than one week, less than three days, or a specified date and time such as the date of expiration). The criteria for when to display the expiration date may be determined based on the duration of the valid period of the advertisement.

Instead of this, or in addition to this, in a case in which the expiration date has passed at the time of the second settlement process, the redisplay of the designated advertisement on the second settlement screen may be discontinued. Alternatively, the fact that the expiration date has already passed may be displayed together with the designated advertisement. The user may be able to determine whether to discontinue the redisplay of the designated advertisement, whose expiration date has passed. The expiration date of the designated advertisement may be stored in the user database along with the identification information of the advertisement.

In a case in which the expiration date of the advertisement content of the designated advertisement has passed at the time of the second settlement process, the advertisement will not be effective even if the advertisement is viewed. In order to avoid such wasteful viewing, it is desirable to discontinue the display of designated advertisements whose expiration dates have passed. On the other hand, the user often does not remember the expiration date of each designated advertisement. Therefore, if the redisplay is automatically discontinued, there is a risk that the user might misunderstand this as an error, thinking the designated advertisement is not being displayed despite having enabled the redisplay setting for it. In this case, it is preferable to display the fact that the expiration date of the designated advertisement has passed, together with the designated advertisement. In addition, if the user can determine whether to discontinue the display or to display the expiration date, it is more convenient for the user.

When the expired designated advertisement is displayed again, the redisplay button 62 does not necessarily need to be displayed. Alternatively, the redisplay button 62 in an inactive state, which cannot be turned on, may be displayed. The advertisement at the top in FIG. 3 illustrates a display of “Expired”, indicating that the expiration data has passed, and an inactive redisplay button 62.

When the advertisement content of a designated advertisement has an expiration date, the server 30 may be configured to determine the time of redisplaying the designated advertisement based on the expiration date. An example of the redisplay time is a specified number of days before the expiration date. For example, it may be three days before the expiration date, two days before the expiration date, or the expiration date. In a case in which a settlement process is not performed on the date determined as described above, the designated advertisement may be redisplayed in association with a subsequent settlement process.

The server 30 may determine the time of redisplaying a designated advertisement based on the settlement history of each user. For example, in the case of a user who has performed code settlement almost every day in the most recent specified period (for example, one month), the designated advertisement may be displayed again at a time relatively close to the expiration date. Alternatively, if the latest use frequency of the code settlement is about once a week, the designated advertisement may be redisplayed at a time relatively far from the expiration date so that the opportunity of redisplay will not be missed.

When there is no designated advertisement, or when the number of advertisement slots 61 is larger than the number of designated advertisements, the settlement completion screen 60 includes one or more normal advertisement slots 61. In this case, the server 30 and the settlement application may be configured to display one or more targeted advertisements determined based on the settlement information of the settlement process in one or more normal advertisement slots 61 displayed after the settlement process. The settlement information may include at least one of the settlement location, the name of the merchant, the type of business of the merchant, the products handled or services provided by the merchant, or the settlement amount. The advertiser may designate which settlement information is used to determine the advertisement to be displayed. Alternatively, the advertisement to be displayed may be determined based on the content of interest registered in advance by the user.

For example, in a case in which the advertiser designates a region including the location of a store of the advertiser as the advertisement range, the advertisement of the advertiser may be displayed in association with a settlement process executed in the designated region. Alternatively, in a case in which the advertiser designates his or her own store, the advertisement of the advertiser may be displayed on the user terminal 11 that has performed settlement at the store. In addition, in a case in which the advertiser designates a genre (for example, restaurants, convenience stores, or supermarkets) to which the business type, the products handled, or the services provided of the advertiser belong, the advertisement of the advertiser may be displayed on the user terminal 11 that has performed settlement in a store belonging to the designated genre. In addition, in a case in which the advertiser designates a settlement amount (for example, 500 yen or more), the advertisement designated by the advertiser may be displayed on the user terminal 11 of the user who paid the settlement amount greater than or equal to the designated amount.

In a case in which the distance between the settlement location and the physical address of the user who has performed settlement is within a first specified distance, an advertisement related to an online service may be displayed in at least one of the one or more normal advertisement slots 61. In this case, the advertisement data transmitted from the server 30 to the user terminal 11 may include data of an advertisement related to an online service to be displayed in at least one of the one or more normal advertisement slots 61. This is because, if the user has performed settlement near the user's home, the user is highly likely to use an online service at the user's home using the user terminal 11 or a personal computer at the user's home after returning home.

In a case in which the distance between the settlement location and the place of work of the user who has performed settlement is within a second specified distance, an advertisement of a store within the specified range including the place of work may be displayed in at least one of the one or more advertisement slots 61. In this case, the advertisement data transmitted from the server 30 to the user terminal 11 may include data of an advertisement related to a store within the specified range from the place of work to be displayed in at least one of the one or more normal advertisement slots 61. This is because, if the user has performed settlement near the place of work, the user is highly likely to make an electronic settlement using the user terminal 11 near the place of work. The first specified distance and the second specified distance may be the same or different from each other.

When the number of designated advertisements exceeds the number of the advertisement slots 61, priorities may be set using the same or similar criteria as those used for targeted advertisements described above, and the advertisements to be redisplayed can be determined based on these priorities, starting with the highest priority. Alternatively, if the advertisements have expiration dates, those with the closest expiration dates may be given priority for display. Even when the number of the advertisement slots 61 is greater than or equal to the number of the designated advertisements, advertisements may be displayed according to the set priorities.

For example, in FIG. 3, as a first display condition, the priority of a designated advertisement is higher than those of the other advertisements, and as a second display condition, the priority is higher as the expiration date of the advertisement content is closer. As a third display condition, the priority of a designated advertisement whose expiration date has expired may be set lower than those of advertisements for which the redisplay setting is not enabled. As a fourth display condition, the priority of an advertisement registered as a favorite in at least one of the code display screen 15 and the settlement completion screen 60 may be set to be higher than those of advertisements for which the redisplay setting is not enabled.

When there are multiple advertisement slots 61, and the multiple advertisement slots 61 include one or more designated advertisement slots 61 and one or more normal advertisement slots 61, designated advertisements may be displayed in the one or more designated advertisement slots 61, and related advertisements determined based on the designated advertisements may be displayed in the one or more normal advertisement slots 61. In this case, the advertisement data transmitted from the server 30 to the user terminal 11 includes data of one or more designated advertisements and data of one or more related advertisements.

Examples of the related advertisements include advertisements of genres (for example, restaurants, convenience store, supermarkets, cake shops, or gift shops) to which the business type, the products handled, or the services provided of the advertiser belong. Alternatively, in a case in which a designated advertisement includes a specific campaign content such as a “increased points campaign”, another advertisement offering increased points as a benefit may be a related advertisement.

Instead of this, or in addition to this, when a favorite advertisement is registered, the designated advertisement and the favorite advertisement or a similar advertisement having one or more points in common with the favorite advertisement may be displayed in multiple advertisement slots 61. In this case, the advertisement data transmitted from the server 30 to the user terminal 11 includes data of the designated advertisement and data of the similar advertisements. For example, in a case in which an advertisement of a product handled in a certain e-commerce (EC) site is registered as a favorite, an advertisement of a similar product in the same EC site may be displayed as a similar advertisement together with the designated advertisement. Alternatively, when an advertisement for a newly released drink or snack is registered as a favorite, an advertisement for another drink or snack that is also newly released may be displayed as a similar advertisement together with the designated advertisement.

Instead of this, or in addition to this, if an advertisement is a gaming advertisement that includes a game element, the user may prefer similar gaming advertisements. Accordingly, other gaming advertisements for which redisplay setting has not been enabled may be displayed in multiple advertisement slots 61 together with the gaming advertisement that is the designated advertisement. In this case, the advertisement data transmitted from the server 30 to the user terminal 11 includes data of one or more designated advertisements and data of the gaming advertisements different from the designated advertisements. The game element includes, but is not limited to, at least one of a lucky draw, a quiz, a game, a puzzle, a roulette, a slot machine, and rock-paper-scissors. For example, the gaming element may include fortune-telling features that display different results on different days or personality diagnostics that change themes every set period of time.

The server 30 may be configured to display a designated advertisement in accordance with a specified action requirement in a case in which the designated advertisement is a user participation type advertisement that gives a benefit to a user in accordance with the specified action requirement. The specified action requirement includes at least one of the number of executions of the action or an execution duration of the action. For example, a benefit may be given if an action (for example, login to a designated site or execution of a game) is executed once a day. In this case, at the time of a certain settlement process, the server 30 and the settlement application may be configured to not display the designated advertisement if the action has been executed on the same day, and to display the designated advertisement if the action has not been executed. In a case in which the designated advertisement is not displayed, the server 30 and the settlement application may display the designated advertisement if the action has not been executed at the time of a settlement process on another day.

The settlement database or the user database may store, for each user, data of a display duration time from the start of the display of the settlement completion screen 60 to the end of the display of the settlement completion screen 60, and data of time slots in which the settlement completion screen 60 is displayed. In this case, the server 30 may be configured to determine the time at which the designated advertisement is displayed such that the designated advertisement is displayed in a time slot in which settlement processes having display duration times longer than the average are most distributed among the multiple time slots.

These multiple time slots can vary widely, for example, they can be simply divided into morning and afternoon, or more specifically into morning, noon, evening, and night. Commuting hours can be added to these divisions, and even consideration of time slots for each day of the week is possible, but not limited to these classifications. For example, if there is a tendency for the display duration time to be longer in the afternoons during holidays, the server 30 and the settlement application may redisplay designated advertisements in the afternoons of holidays. The times of such redisplay may be specified by the advertiser or the user. In this case, the user database may be capable of storing the redisplay times of designated advertisements for each user.

The time slot in which the designated advertisement is displayed may be a time slot in which the display duration time is longer than other time slots. For example, the total display duration time of each of multiple time slots may be calculated, and the time slot in which the total display duration time is the longest may be used. In addition, the display time slot of designated advertisements may be set to one or more time slots in which multiple display duration times longer than or equal to a specified time exist.

Alternatively, the server 30 may be configured to display designated advertisements in a settlement situation different from the settlement process in which the redisplay setting was enabled. In other words, the designated advertisements may be displayed in one or more designated advertisement slots 61 of the second settlement screen (settlement completion screen 60) displayed in a settlement situation different from that of the first settlement process. The settlement situation may be, for example, at least one of the day of the week of the settlement, the time of the settlement, the time slot of the settlement, the store where the settlement is performed, the settlement amount, or the type of product or service involved in the settlement, but is not limited to these.

For example, if a redisplay button 62 is turned on within a specified range from the place of work of the user or on a weekday, there is a possibility that the user has not had time to view the advertisement because the user has been busy at work. In this case, the server 30 and the settlement application may redisplay designated advertisements on the second settlement screen (the settlement completion screen 60) in association with the second settlement process executed within the specified range of the physical address or on a holiday that is different from the settlement situation of the first settlement process. Alternatively, in a case in which the redisplay button 62 is turned on in the first settlement process at a convenience store, the server 30 and the settlement application may redisplay designated advertisements on the second settlement screen (the settlement completion screen 60) in association with the second settlement process at a place different from the convenience store.

### Method for Displaying Advertisement on Settlement Screen

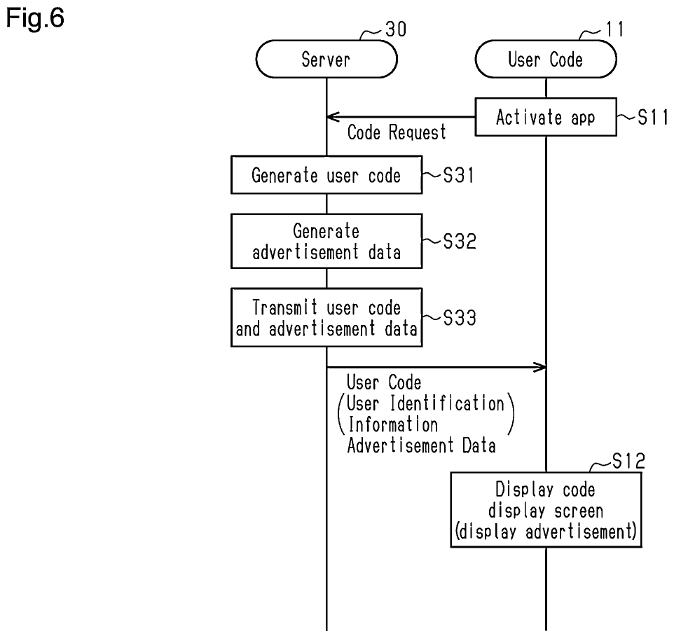

A method for displaying an advertisement on a settlement screen will be described with reference to FIGS. 6 to 10. A case will be described in which code settlement is performed by a store scan system via a user terminal 11 and a merchant terminal 20. The process executed by the user terminal 11 is shown in steps S11 to S17, the process executed by the merchant terminal 20 is shown in steps S21 and S22, and the process executed by the server 30 is shown in steps S31 to S47.

A display process of the code display screen 15 will be described with reference to FIG. 6.

In step S11, the user activates (for example, launches or reloads the code of) the settlement application (also simply referred to as an “app”) installed in the user terminal 11. The settlement application then transmits a code request to the server 30. Upon receiving the code request, the server 30 generates a user code 12 in step S31. The user code 12 includes user identification information.

Subsequently, in step S32, the server 30 generates advertisement data to be displayed in the advertisement slots 16, 17. More specifically, the server 30 refers to the advertisement database to obtain data of an advertisement to be distributed to a corresponding user. Further, the server 30 refers to the user database to obtain favorite registration information of advertisements for that user. When there is an advertisement registered as a favorite among the advertisements to be distributed, the server 30 attaches the registered information to the corresponding advertisement data and uses it as the advertisement data for distribution.

In step S33, the server 30 transmits the generated user code 12 and the advertisement information to the user terminal 11. When receiving the user code 12 and the advertisement data, the settlement application generates two-dimensional coded 13, 14 from the user code 12. Then, in step S12, the settlement application displays the code display screen 15 on the user terminal 11. In this manner, the server 30 and the settlement application display the code display screen 15, which includes the user codes 12, 13, 14 and the advertisement slots 16, 17, on the user terminal 11. Accordingly, the advertisements included in the advertisement data is displayed in the advertisement slots 16, 17 of the code display screen 15.

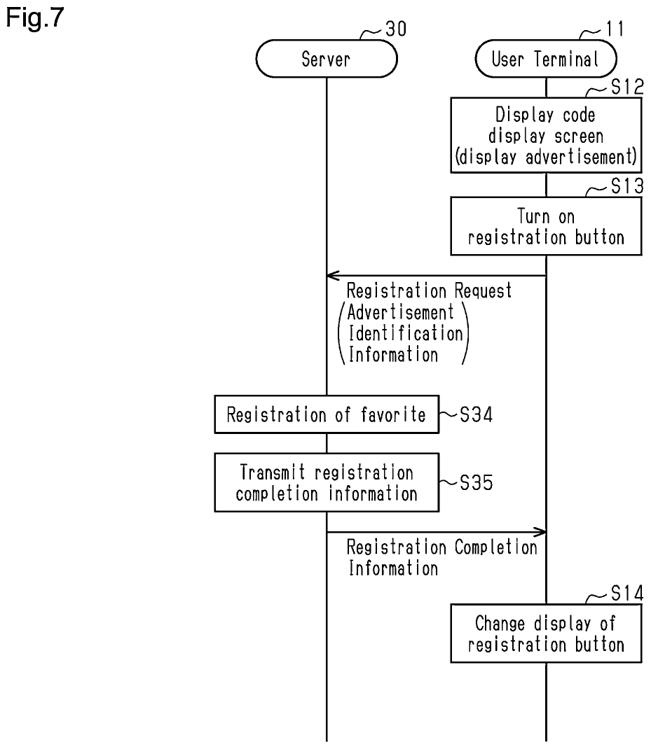

The advertisement favorite registration process will be described with reference to FIG. 7. An example of the favorite registration from the code display screen 15 will be described, but the favorite registration can be similarly performed even from the settlement completion screen 60, which includes the registration button 18.

After step S12, the user views the advertisements in the advertisement slots 16, 17. In step S13, when the user turns on the registration button 18 on the code display screen 15 (first settlement screen), the settlement application transmits a registration request to the server 30 together with the advertisement identification information of the turned-on advertisement.

When receiving the registration request, the server 30 updates the user database so as to register the corresponding advertisement as a favorite based on the advertisement identification information in step S34. In the subsequent step S35, the server 30 transmits registration completion information of the favorite advertisement to the user terminal 11. When the user terminal 11 receives the registration completion information, the settlement application changes the display of the registration button 18 of the turned-on advertisement from the off state to the on state in step S14.

When the user turns off the registration button 18 in the on state or turns on the registration cancellation button 51 on the list screen 50, the settlement application transmits a registration cancellation request for the operated advertisement to the server 30. Upon receiving the registration cancellation request, the server 30 updates the user database so as to cancel the favorite registration of the corresponding advertisement. Thereafter, the server 30 transmits registration cancellation completion information to the user terminal 11. When the user terminal 11 receives the registration cancellation completion information, the settlement application changes the display of the registration button 18 from the on state to the off state or deletes the corresponding favorite advertisement from the list screen 50.

The settlement application may transmit a registration request to the server 30 not in response to an operation of the registration button 18, but in response to another operation, for example, closing of the settlement screen on which the registration button 18 is displayed or switching to another screen. In this case, the settlement application may change the display of the registration button 18 of the step S14 in response to turning on of the registration button 18. Similarly, the cancellation of a favorite registration may be performed by transmitting a registration cancellation request to the server 30 when the settlement screen or the list screen 50 on which the registration button 18 is displayed is closed or when the screen is switched to another screen.

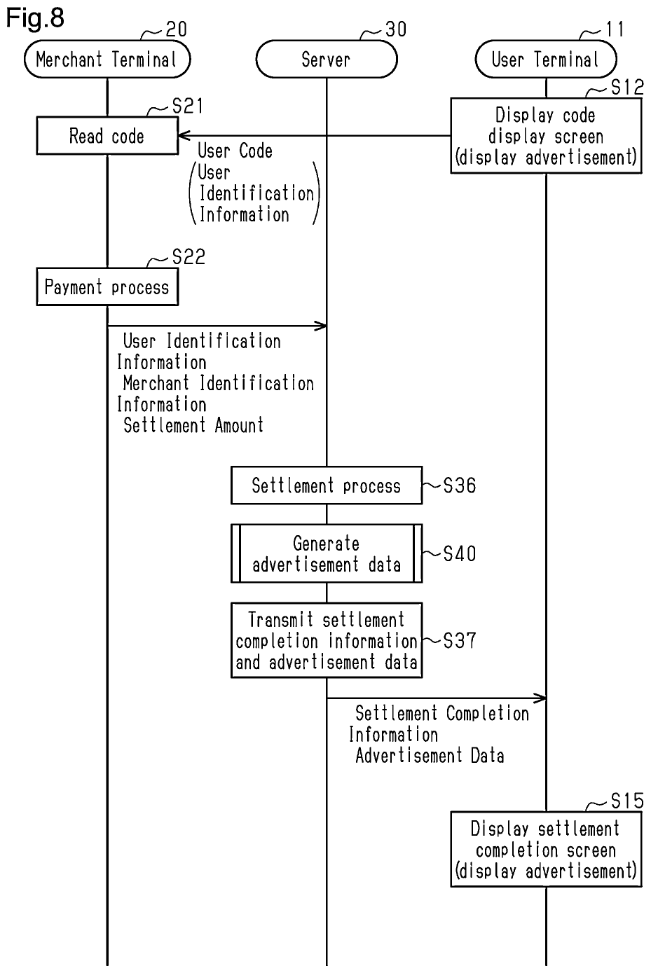

The settlement process will be described with reference to FIG. 8.

In step S21, the merchant reads the user code 12 by using the code scanner 21. Specifically, the merchant scans the two-dimensional code 13 (or the code 14) with the code scanner 21, and the merchant terminal 20 decodes the two-dimensional code 13 (or the code 14) to obtain the user code 12.

In the subsequent step S22, when the merchant terminal 20 executes a payment process, the merchant terminal 20 transmits settlement information to the server 30. The settlement information includes at least the user identification information, the merchant identification information (store identification information), and the settlement amount.

When receiving the settlement information, the server 30 performs a settlement process in step S36. Subsequently, in step S40, the server 30 refers to the advertisement database and the user database to generate advertisement data to be displayed in the advertisement slot 61.

In the subsequent step S37, the server 30 transmits settlement completion information and the generated advertisement data to the user terminal 11. When the user terminal 11 receives the settlement completion information and the advertisement data, the settlement application causes the user terminal 11 to display the settlement completion screen 60 in step S15. In this manner, the server 30 and the settlement application display the settlement completion screen 60, which includes the advertisement slot 61, on the user terminal 11. Further, an advertisement included in the advertisement data is displayed in the advertisement slot 61.

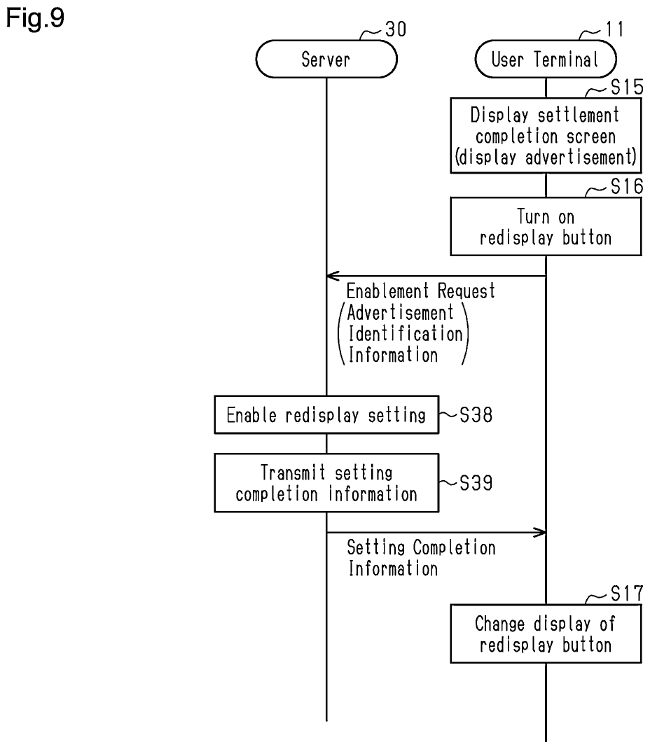

An advertisement redisplay setting process will be described with reference to FIG. 9. An example of the redisplay setting from the settlement completion screen 60 will be described, but the redisplay setting can be similarly performed from the code display screen 15, which includes the redisplay button 62.

After step S15, the user views the advertisements in the advertisement slots 61. When the user turns on a redisplay button 62 of the settlement completion screen 60 (first settlement screen) in step S16, the settlement application transmits an enablement request for redisplay setting to the server 30 together with the advertisement identification information of the advertisement for which the redisplay button 62 has been turned on.

Upon receiving the enablement request, the server 30 updates the user database so as to enable the redisplay setting of the corresponding advertisement based on the advertisement identification information in step S38. In the subsequent step S39, the server 30 transmits setting completion information to the user terminal 11. When the user terminal 11 receives the setting completion information, the settlement application changes the display of the redisplay button 62 of the turned-on advertisement from the off state to the on state in step S17.

The settlement application may transmit an enablement request to the server 30 not in response to an operation of a redisplay button 62, but in response to another operation, for example, closing of the settlement screen on which the redisplay button 62 is displayed or switching to another screen. In this case, the settlement application may change the display of the redisplay button 62 of the step S17 in response to turning on of the redisplay button 62. After receiving the enablement request, the server 30 may update the user database so as to enable the redisplay setting.

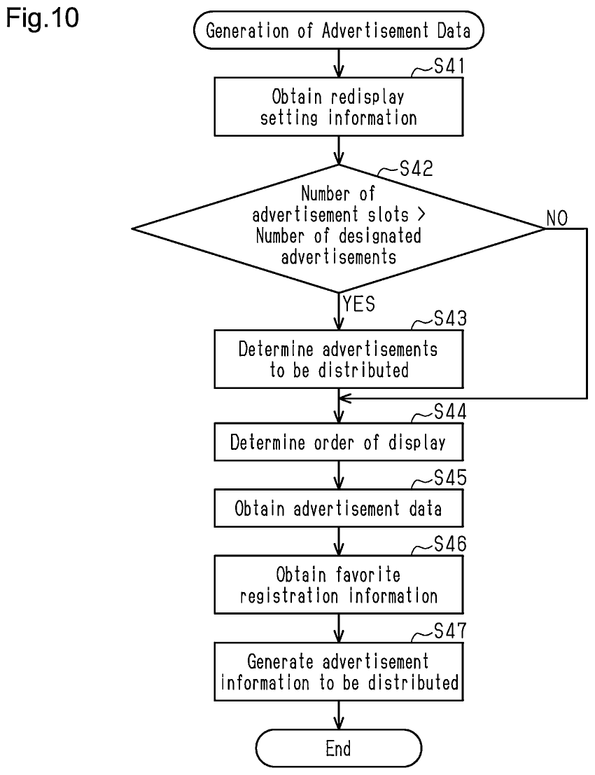

Referring to FIG. 10, the generation of advertisement data in step S40 will be described in more detail.

First, in step S41, the server 30 refers to the user database to obtain redisplay setting information of a corresponding user.

In step S42, the server 30 determines whether the number of the advertisement slots 61 is larger than the number of the designated advertisements. In a case in which the number of the advertisement slots 61 is larger than the number of the designated advertisements in step S42 (including a case in which there is no designated advertisement), the server 30 determines advertisements to be distributed in step S43. Specifically, when there is a designated advertisement, the server 30 determines advertisements to be distributed together with the designated advertisement from advertisements for which the redisplay setting is not enabled. When there is no designated advertisement, the server 30 determines an advertisement to be distributed.

After step S43, the server 30 determines the display order of the advertisements to be distributed based on a specified priority in step S44. The priority can be determined based on at least one of the above-described first to third display conditions. When the number of the advertisement slots 61 is less than or equal to the number of the designated advertisements in step S42, the server 30 determines the designated advertisement to be displayed based on the priority among the multiple designated advertisements in step S44. The priority at this time can be determined based on a specified condition (for example, the second display condition). When there is one advertisement slot 61, step S44 can be omitted.

In step S45, the server 30 refers to the advertisement database to obtain the data of the advertisements to be distributed. In step S46, the server 30 refers to the user database to obtain favorite registration information of the corresponding user. When there is an advertisement registered as a favorite, the server 30 compares the identification number of that advertisement with the identification number of the advertisement obtained in step S45. When there is an advertisement registered as a favorite among the advertisements to be distributed, the server 30 attaches the registered information to the corresponding advertisement data.

When the advertisements displayed in the advertisement slots 61 do not include favorite registration buttons 18, step S46 can be omitted. Step S46 may be executed before any one of steps S41 to S45, or may be executed simultaneously with step S41.

In step S47, the server 30 generates advertisement information for distribution that includes the advertisement data, the favorite registration information, and the display order of the advertisements. Thus, when step S36 shown in FIG. 8 is the second settlement process, the data of a designated advertisement is included in the advertisement data transmitted in step S37. As a result, in step S15, the designated advertisement is displayed again on the settlement completion screen 60, which is the second settlement screen.

### Operation of Present Disclosure

Various advertisements are always displayed in the advertisement slots 17, 61, in which the targeted advertisements are displayed. At normal times, the advertisements displayed in the advertisement slots 17, 61 cannot be designated by the user. However, designated advertisements, for which the redisplay setting has been enabled, are displayed on the settlement screen 15, 60 in subsequent transactions. In other words, the advertisements designated in advance by the user can be displayed again in the advertisement slots 17, 61.

In order to view favorite advertisements, the user needs to open the list screen 50. Therefore, when an advertisement content has an expiration date, the user may fail to view the advertisement content before the expiration date arrives. In this regard, since a designated advertisement is automatically redisplayed when the user has enabled the redisplay setting, the user is unlikely to miss the designated advertisement. In this manner, the redisplay setting has an effect of reminding the user to view advertisements.

Further, since favorite advertisements are accumulated on the list screen 50, the user needs to manage the favorite advertisements. In contrast, since designated advertisements will be redisplayed later if the redisplay buttons 62 are pressed, it does not take time and labor for management.

The favorite registration and the redisplay setting both serve as records of a user's interest in accessing advertisements, thus providing criteria for determining subsequent advertisement distribution. For example, with the favorite registration, it is possible to obtain the log of the “registration” actions and the log of the subsequent “viewing” actions from the list screen 50. Similarly, with the redisplay setting, it is possible to obtain the log of the “redisplay setting” actions and the logs of the subsequent “viewing” actions for the redisplayed advertisements. Moreover, in the case of the redisplay setting, since there is a possibility that the user repeatedly enables the redisplay setting of the same advertisement, the log of the second and subsequent actions can be obtained in that case.

### Advantages of Present Disclosure

The present disclosure has the following advantages.

(1) When the redisplay setting is enabled for an advertisement in the first settlement process, the advertisement is redisplayed on the second settlement screen as the designated advertisement in the subsequent second settlement process. Therefore, even if the user does not have time to view the advertisement at the time of the first settlement process, the user can view the designated advertisement on the second settlement screen later. Thus, advertisements can be effectively displayed on the settlement screen having a short display duration time.

(2) The settlement completion screen 60 is displayed immediately after a settlement process, thereby reflecting the user's latest consumption trends in the settlement information. Therefore, by determining advertisements to be displayed in the normal advertisement slots 61 based on the settlement information, it is possible to distribute advertisements in consideration of the user's latest trends. Moreover, since the settlement completion screen 60 also displays designated advertisements for which the user has enabled the redisplay setting, it is possible to increase the interest of the user in the advertisement slots 61

(3) In a case in which the settlement location is within the first specified distance from the physical address of the user, that is, near their home, the user is highly likely to return to their home thereafter. In this case, after the settlement process, the user is more likely to use an online service such as online shopping at home than to shop at an actual store. If an advertisement of the online service is distributed to such a user, the advertisement effectiveness is high. In this manner, by predicting the behavior of the user from the settlement information, it is possible to distribute advertisements with a higher advertisement effectiveness.

(4) In a case in which the settlement location is within the second specified distance from the user's place of work, that is, near the place of work, the user is highly likely to shop at an actual store before returning home. If an advertisement of the actual store near the place of work is distributed to such a user, the advertisement effectiveness is high. Further, when an advertisement of an actual store at which the user has made a purchase is selected from the past settlement history of the user, the advertisement effectiveness is further enhanced. In this manner, by predicting the behavior of the user from the settlement information, it is possible to distribute advertisements with a higher advertisement effectiveness.

(5) A designated advertisement is an advertisement for which the user has performed an action of enabling the redisplay setting in order to view the advertisement. Therefore, by displaying advertisements related to the designated advertisement, in which the user has expressed interest or concern, a cross-selling effect is expected to be made by the advertisements. Even if the user is interested in multiple advertisements on the settlement screen and has time to view only one advertisement, it is possible to prevent the user from missing the other advertisements by enabling the redisplay setting for the other advertisements. In this manner, if the redisplay setting can be enabled continuously for an advertisement, it is possible to achieve a sequential viewing of advertisement.

(6) A gaming advertisement can provide enjoyment to the user; however, because it is necessary to transition from the advertisement to the game screen to play the game, it takes time to complete the viewing. Therefore, even if the user transitions to the game screen, there is a possibility that the user might not proceed to play the game. In a such case, by enabling the redisplay setting for the advertisement, the user has the opportunity to play the game at a later time. Additionally, a user who favors a gaming advertisement is likely to show interest in other gaming advertisements as well. Therefore, by displaying other gaming advertisements alongside a designated advertisement, it is possible to increase the frequency of advertisement views by the user.

(7) An advertisement registered as a favorite is an advertisement in which the user has expressed interest or concern. Therefore, in a case in which the number of the advertisement slots 61 is larger than the number of designated advertisements, a favorite advertisement or a similar advertisement having one or more points in common with the favorite advertisement is displayed, so that an advertisement in which the user is interested can be displayed.

(8) When redisplay of a designated advertisement is delayed, there is a possibility that the expiration date of the advertisement content has passed at the time of the redisplay. In addition, there is a possibility that the expiration date of the advertisement content arrives while the user, who is interested in the advertisement, postpones the viewing of the designated advertisement and repeatedly enables the redisplay setting. Therefore, by displaying the expiration date together with the designated advertisement, it is possible to prompt the user to view the advertisement before the expiration date.

(9) Since the time of redisplaying the designated advertisement is determined based on the expiration date of the designated advertisement, the designated advertisement is displayed at the time when the user wants to view the advertisement. Thus, it is possible to appropriately remind the user to view the expiration date of the advertisement, thereby preventing the user from missing the advertisement.

(10) Since the code display screen 15 and the settlement completion screen 60 are respectively displayed before and after a settlement process, the display duration time thereof tends to be short. However, the code display screen 15 can be displayed even when a settlement process is not being performed. Therefore, the user may view a favorite advertisement or check the settlement history by operating the favorite advertisement display button 19 from the code display screen 15 when there is time. Furthermore, if there is no subsequent settlement process, the user can choose to leave the settlement completion screen 60 displayed. In such a case, the display duration time for the code display screen 15 or the settlement completion screen 60 may be extended. For example, a case will now be discussed in which a user tends to keep displaying the settlement completion screen 60 for a longer time at night than other times. In this case, since there is a high possibility that the user is viewing advertisements on the settlement completion screen 60 at night, displaying a designated advertisement in association with a night-time settlement process increases the likelihood of the user viewing the designated advertisement. Therefore, by determining the time for displaying the designated advertisement based on the past display duration time, it is possible to increase the visitation rate to the website linked to the advertisement.

(11) The fact that the user enables the redisplay setting means that the user has no time to view the advertisement at that time. In addition, since the code settlement is performed in an actual store, the behavior pattern of the user is reflected in the settlement situation. It is thus inferred that the situation in which the first settlement process, for which the redisplay setting has been enabled, is performed is not conducive for the user to view advertisements. In this regard, if a designated advertisement is redisplayed in association with the second settlement process, which is executed in a situation different from the settlement situation for the first settlement process, there is a higher possibility that the user can take time to view the advertisement.

(12) User participation type advertisements exist that promote repeated viewing by imposing restrictions on either the number of executions of an action or the duration of the action. Such an advertisement typically shows phrases like “once a day” or “viewing consecutively for a set number of days.” Displaying such a user participation type advertisement as a designated advertisement reminds a user to take an action, thus offering high convenience to the user. Further, for example, in a case in which there is a requirement for an action once a day, if a designated advertisement is redisplayed when the specified action is not being executed, the convenience of the user is high. Therefore, by determining the time for displaying a designated advertisement according to a specified action requirement, the value of the redisplay setting is further increased

### MODIFICATIONS

The above-described embodiment may be modified as follows. The above-described embodiment and the following modifications can be combined as long as the combined modifications remain technically consistent with each other.

### First Modification

The system 10 may be formed by a single server 30 (one computer) including a database 40. Alternatively, the system 10 may include multiple servers 30 that respectively execute multiple functions such as a settlement process, transmission of data for displaying a settlement screen, distribution of advertisements, registration of favorites, or enablement of redisplay setting. In this case, each server 30 may include a necessary database (for example, a user database, a merchant database, a settlement database, and an advertisement database).

### Second Modification

The advertisement displaying system 10 may execute various processes of the present disclosure by using a first server 30 (a settlement server or a settlement system), which provides an electronic settlement service, and a second server 30 (an advertisement distribution server or an advertisement distribution system), which provides an advertisement distribution service. In this case, steps S32, S34, S35, and S38 to S47 related to the display of advertisements may be executed by the second server 30, and the first server 30 or the settlement application may request the second server 30 to execute S32, S34, S35, S38 to S40, and the second server 30 may transmit the execution results to the first server 30 or the settlement application.

### Third Modification

The advertisement displaying system 10 may execute various processes of the present disclosure by using a first server 30, which generates user codes, a second server 30 (a settlement server or a settlement system), which provides an electronic settlement service, and a third server 30 (an information transmission server or an information transmission system), which transmits settlement information and advertisement data. In this case, the first server 30 may execute step S31 (user code generation), the second server 30 may execute step S36 (settlement process), and the third server 30 may execute steps S32 to S35 and S37 to S47.

### Fourth Modification

The redisplay buttons 62 may be displayed on the advertisements of the code display screen 15. Alternatively, instead of displaying the redisplay buttons 62 on the advertisements in the code display screen 15, the registration buttons 18 may be displayed. Instead of displaying the registration buttons 18 on the advertisements in the settlement completion screen 60, the redisplay buttons 62 may be displayed. Furthermore, it is not necessary to display the registration buttons 18 on the advertisements in both the code display screen 15 and the settlement completion screen 60. In other words, the system 10 is not required to offer a service for registering advertisements as favorites.

### Aspects

Aspects that are understood from the above-described embodiment and modifications will hereafter be described.

[1] An advertisement displaying system, including
a settlement information transmission unit configured to transmit, to a user terminal, data for displaying a settlement screen in association with a settlement process, the settlement screen including one or more advertisement slots, and an advertisement displayed in the one or more advertisement slots including a redisplay button,
an advertisement transmission unit configured to
   transmit, to the user terminal, advertisement data to be displayed in the one or more advertisement slots, and
   when the redisplay button is turned on, enable redisplay setting of an advertisement including the turned-on redisplay button as a designated advertisement, and
when the redisplay setting of one or more of the designated advertisements is enabled, the advertisement data includes data of one or more of the designated advertisements to be displayed in at least one of the one or more advertisement slots.

[2] The advertisement displaying system according to [1], in which
the settlement screen is a settlement completion screen displayed on the user terminal after the settlement process,
an advertisement slot of the one or more advertisement slots in which the designated advertisement is not displayed is a normal advertisement slot,
when the one or more advertisement slots include one or more of the normal advertisement slots, the advertisement data includes data of one or more targeted advertisements to be displayed in the one or more of the normal advertisement slots, the one or more targeted advertisements being determined based on settlement information of the settlement process, and
the settlement information includes at least one of a settlement location, a name of a merchant, a type of business of the merchant, products handled or services provided by the merchant, or a settlement amount.

[3] The advertisement displaying system according to [2] further including a user database configured to store data of a user who uses the user terminal, in which
the user database includes data of a physical address, and
when a distance between the settlement location and the physical address is within a first specified distance, the advertisement data includes data of an advertisement related to an online service to be displayed in at least one of the one or more normal advertisement slots.

[4] The advertisement displaying system according to [2] or [3] further including a user database configured to store data of a user who uses the user terminal, in which
the user database includes data of a place of work, and
when the distance between the settlement location and the place of work is within a second specified distance, the advertisement data includes data of an advertisement related to a store within a specified range from the place of work to be displayed in at least one of the one or more normal advertisement slots.

[5] The advertisement displaying system according to any one of [1] to [4], in which
the one or more advertisement slots include multiple advertisement slots,
the advertisement data includes data of the one or more designated advertisements and data of one or more related advertisements determined based on the one or more designated advertisements, the data of the one or more designated advertisements and the data of the one or more related advertisements being displayed in the multiple advertisement slots.

[6] The advertisement displaying system according to any one of [1] to [5], in which
the one or more advertisement slots include multiple advertisement slots,
the designated advertisement is a gaming advertisement including a game element,
the advertisement data includes data of the one or more designated advertisements and data of a gaming advertisement different from the designated advertisement, the data of the one or more designated advertisements and the data of the gaming advertisement being displayed in the multiple advertisement slots, and
the game element includes at least one of a lucky draw, a quiz, a game, a puzzle, a roulette, a slot machine, and rock-paper-scissors.

[7] The advertisement displaying system according to any one of [1] to [6] further including a user database configured to store data of a user who uses the user terminal, in which
advertisements displayed in the one or more advertisement slots include a favorite registration button,
the advertisement transmission unit is configured to register, in the user database, an advertisement for which the favorite registration button has been turned on as a favorite advertisement,
the one or more advertisement slots include multiple advertisement slots,
the advertisement data includes data of the designated advertisement and data of the favorite advertisement or a similar advertisement having one or more points in common with the favorite advertisement, the data of the designated advertisement and the data of the favorite advertisement or the similar advertisement being displayed in the multiple advertisement slots.

[8] The advertisement displaying system according to any one of [1] to [7], in which, when an advertisement content of the designated advertisement has an expiration date, the expiration date is displayed in the designated advertisement.

[9] The advertisement displaying system according to any one of [1] to [8], in which, when an advertisement content of the designated advertisement has an expiration date, the advertisement transmission unit is configured to determine a time to display the designated advertisement based on the expiration date.

[10] The advertisement displaying system according to any one of [1] to [9], further including a settlement database configured to store a history of multiple settlement processes, in which
the settlement database stores data of a display duration time from a start of display of the settlement screen to an end of the display, and data of a time slot in which the settlement screen is displayed, and
the advertisement transmission unit is configured to determine a time at which the designated advertisement is displayed such that the designated advertisement is displayed in a time slot in which a largest number of settlement processes having the display duration time longer than an average are distributed among multiple time slots.

[11] The advertisement displaying system according to any one of [1] to [10], further including a settlement database configured to store a history of multiple settlement processes, in which
the settlement database stores data related to at least one of a settlement location, a settlement time, and a settlement day of the week as a settlement situation in which the settlement process has been performed, and
the advertisement transmission unit is configured to display the designated advertisement in a settlement situation different from a settlement process for which the redisplay setting has been enabled.

[12] The advertisement displaying system according to any one of [1] to [11], in which
the advertisement transmission unit is configured to display the designated advertisement in accordance with a specified action requirement in a case in which the designated advertisement is a user participation type advertisement that gives a benefit to a user in accordance with the specified action requirement, and
the specified action requirement includes at least one of a number of executions of the action or an execution duration of the action.

[13] An advertisement displaying system, including one or more servers, in which
at least one of the one or more servers is configured to transmit, to a user terminal, data for displaying a settlement screen in association with a settlement process, the settlement screen including one or more advertisement slots, and an advertisement displayed in the one or more advertisement slots including a redisplay button,
at least one of the one or more servers is configured to transmit advertisement data to be displayed in the one or more advertisement slots,
at least one of the one or more servers is configured to enable, when the redisplay button is turned on, a redisplay setting of an advertisement including the turned-on redisplay button as a designated advertisement, and
when the redisplay setting of one or more of the designated advertisements is enabled, the advertisement data includes data of one or more of the designated advertisements to be displayed in at least one of the one or more advertisement slots.

[14] An advertisement displaying method, the method causing one or more computers to:
transmit, to a user terminal, first data for displaying a first settlement screen in association with a first settlement process, the first settlement screen including one or more first advertisement slots, and an advertisement displayed in the one or more first advertisement slots including a redisplay button;
when the redisplay button is turned on in the first settlement screen, enable redisplay setting of an advertisement including the turned-on redisplay button as a designated advertisement; and
transmit, to the user terminal, second data for displaying a second settlement screen in association with a second settlement process after the redisplay setting is enabled, the second settlement screen including one or more second advertisement slots for displaying an advertisement, and the second data including data of one or more of the designated advertisement to be displayed in the one or more second advertisement slots.

[15] A computer program for causing a user terminal to:
display a settlement screen in association with a settlement process, the settlement screen including one or more advertisement slots, and an advertisement displayed in the one or more advertisement slots including a redisplay button,
when the redisplay button is turned on, transmit, to a server, information of the advertisement for which the redisplay button has been turned on, the advertisement for which the redisplay button has been turned on being a designated advertisement; and
display the designated advertisement in at least one of the one or more advertisement slots when receiving advertisement data including the data of the designated advertisement.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An advertisement displaying system, comprising one or more servers, wherein
at least one of the one or more servers is configured to transmit, to a user terminal, data for displaying a settlement screen in association with a settlement process, the settlement screen including one or more advertisement slots, and an advertisement displayed in the one or more advertisement slots including a redisplay button,
at least one of the one or more servers is configured to transmit advertisement data to be displayed in the one or more advertisement slots,
at least one of the one or more servers is configured to enable, when the redisplay button is turned on, a redisplay setting of an advertisement including the turned-on redisplay button as a designated advertisement, and
when the redisplay setting of one or more of the designated advertisements is enabled, the advertisement data includes data of one or more of the designated advertisements to be displayed in at least one of the one or more advertisement slots.

2. The advertisement displaying system according to claim 1, wherein
the settlement screen is a settlement completion screen displayed on the user terminal after the settlement process,
an advertisement slot of the one or more advertisement slots in which the designated advertisement is not displayed is a normal advertisement slot,
when the one or more advertisement slots include one or more of the normal advertisement slots, the advertisement data includes data of one or more targeted advertisements to be displayed in the one or more of the normal advertisement slots, the one or more targeted advertisements being determined based on settlement information of the settlement process, and
the settlement information includes at least one of a settlement location, a name of a merchant, a type of business of the merchant, products handled or services provided by the merchant, or a settlement amount.

3. The advertisement displaying system according to claim 2, further comprising a user database configured to store data of a user who uses the user terminal, wherein
the user database includes data of a physical address, and
when a distance between the settlement location and the physical address is within a first specified distance, the advertisement data includes data of an advertisement related to an online service to be displayed in at least one of the one or more normal advertisement slots.

4. The advertisement displaying system according to claim 2, further comprising a user database configured to store data of a user who uses the user terminal, wherein
the user database includes data of a place of work, and
when the distance between the settlement location and the place of work is within a second specified distance, the advertisement data includes data of an advertisement related to a store within a specified range from the place of work to be displayed in at least one of the one or more normal advertisement slots.

5. The advertisement displaying system according to claim 1, wherein
the one or more advertisement slots include multiple advertisement slots, and
the advertisement data includes data of the one or more designated advertisements and data of one or more related advertisements determined based on the one or more designated advertisements, the data of the one or more designated advertisements and the data of the one or more related advertisements being displayed in the multiple advertisement slots.

6. The advertisement displaying system according to claim 1, wherein
the one or more advertisement slots include multiple advertisement slots,
the designated advertisement is a gaming advertisement including a game element,
the advertisement data includes data of the one or more designated advertisements and data of a gaming advertisement different from the designated advertisement, the data of the one or more designated advertisements and the data of the gaming advertisement being displayed in the multiple advertisement slots, and
the game element includes at least one of a lucky draw, a quiz, a game, a puzzle, a roulette, a slot machine, and rock-paper-scissors.

7. The advertisement displaying system according to claim 1, further comprising a user database configured to store data of a user who uses the user terminal, wherein
advertisements displayed in the one or more advertisement slots include a favorite registration button,
at least one of the one or more servers is configured to register, in the user database, an advertisement for which the favorite registration button has been turned on as a favorite advertisement,
the one or more advertisement slots include multiple advertisement slots, and
the advertisement data includes data of the designated advertisement and data of the favorite advertisement or a similar advertisement having one or more points in common with the favorite advertisement, the data of the designated advertisement and the data of the favorite advertisement or the similar advertisement being displayed in the multiple advertisement slots.

8. The advertisement displaying system according to claim 1, wherein, when an advertisement content of the designated advertisement has an expiration date, the expiration date is displayed in the designated advertisement that is redisplayed.

9. The advertisement displaying system according to claim 1, wherein, when an advertisement content of the designated advertisement has an expiration date, at least one of the one or more servers is configured to determine a time to display the designated advertisement based on the expiration date.

10. The advertisement displaying system according to claim 1, further comprising a settlement database configured to store a history of multiple settlement processes, wherein
the settlement database stores data of a display duration time from a start of display of the settlement screen to an end of the display, and data of a time slot in which the settlement screen is displayed, and
at least one of the one or more servers is configured to determine a time at which the designated advertisement is displayed such that the designated advertisement is displayed in a time slot in which a largest number of settlement processes having the display duration time longer than an average are distributed among multiple time slots.

11. The advertisement displaying system according to claim 1, further comprising a settlement database configured to store a history of multiple settlement processes, wherein
the settlement database stores data related to at least one of a settlement location, a settlement time, and a settlement day of the week as a settlement situation in which the settlement process has been performed, and
at least one of the one or more servers is configured to display the designated advertisement in a settlement situation different from a settlement process for which the redisplay setting has been enabled.

12. The advertisement displaying system according to claim 1, wherein
at least one of the one or more servers is configured to display the designated advertisement in accordance with a specified action requirement in a case in which the designated advertisement is a user participation type advertisement that gives a benefit to a user in accordance with the specified action requirement, and
the specified action requirement includes at least one of a number of executions of the action or an execution duration of the action.

13. An advertisement displaying method, the method comprising causing one or more computers to:
transmit, to a user terminal, first data for displaying a first settlement screen in association with a first settlement process, the first settlement screen including one or more first advertisement slots, and an advertisement displayed in the one or more first advertisement slots including a redisplay button;
when the redisplay button is turned on in the first settlement screen, enable redisplay setting of an advertisement including the turned-on redisplay button as a designated advertisement; and
transmit, to the user terminal, second data for displaying a second settlement screen in association with a second settlement process after the redisplay setting is enabled, the second settlement screen including one or more second advertisement slots for displaying an advertisement, and the second data including data of one or more of the designated advertisement to be displayed in the one or more second advertisement slots.

14. A non-transitory computer readable medium storing a computer program configured to cause a user terminal to:
display a settlement screen in association with a settlement process, the settlement screen including one or more advertisement slots, and an advertisement displayed in the one or more advertisement slots including a redisplay button;
when the redisplay button is turned on, transmit, to a server, information of the advertisement for which the redisplay button has been turned on, the advertisement for which the redisplay button has been turned on being a designated advertisement; and
display the designated advertisement in at least one of the one or more advertisement slots when receiving advertisement data including the data of the designated advertisement.
